(19) United States
(12) Patent Application Publication
(10) Pub. No.: US 2010/0187801 A1
(43) Pub. Date: Jul. 29, 2010

(54) Children's organizational notebooks

(76) Inventors: Frances M. Ramos-Dones, San Juan, PR (US); Mario De La Cruz, San Juan, PR (US)

Correspondence Address: LITMAN LAW OFFICES, LTD., POST OFFICE BOX 41200, SOUTH STATION, ARLINGTON, VA, 22204, US

(21) Appl. No.: 12/656,243

(22) Filed: Jan. 21, 2010

Related U.S. Application Data
(60) Provisional application No. 61/202,096, filed on Jan. 28, 2009.

(51) Int. Cl. B42D 1/00; B42D 3/12; B42D 3/18

(52) U.S. Cl. 281/16; 281/31

(57) ABSTRACT

The children's organizational notebooks are a system of calligraphy notebooks that are color-coded to relate to a particular academic class or subject. For example, a green notebook could relate to a computer class, a red notebook could relate to a science class, etc. The notebooks are fashioned to employ different calligraphy (first, second, third, quadrille 5 mm, 6 mm, 7 mm and regular lines). As presently contemplated, the notebooks will be available in eight different, bright colors.

### CROSS-REFERENCE TO RELATED APPLICATION

This application claims the benefit of U.S. Provisional Patent Application Ser. No. 61/202,096, filed Jan. 28, 2009.

### BACKGROUND OF THE INVENTION

1. Field of the Invention

The present invention generally relates to organizational instructional systems, and more particularly, to children's organizational notebooks that enable the elementary education student to organize and prioritize instructional materials.

2. Description of the Related Art

Acquiring good study habits is essential to academic success. One aspect of acquiring such habits is that of organization. Students at the elementary level usually lack organizational skills. This lack of organization translates into disarray in their lockers, desks, notebooks, etc. Often, the student brings the wrong notebook home or to a particular class, further inhibiting the learning process. Most experts agree that organizational skills are learned rather than inherited. It is also agreed that the earlier these skills are learned the better the student's chances for success in the academic environment and also in life.

Psychologists and child specialists strongly advocate the use of color as a medium to raise a child's attention level. Heretofore, teachers and parents in the elementary grades utilized various methods (stickers, numbers, color markers, etc.) to mark and differentiate notebooks for organizational purposes. Since everyone was using a different method, there was no continuity and the mélange created more confusion for the students. The elementary education sector would certainly welcome a uniform system for identifying notebooks to enhance the students' organizational abilities. Thus, children's organizational notebooks solving the aforementioned problems are desired.

### SUMMARY OF THE INVENTION

The children's organizational notebooks are a system of calligraphy notebooks/first penmanship notebooks that are color-coded to relate to a particular academic class or subject. For example, a green notebook could relate to a computer class, a red notebook could relate to a science class, etc. The notebooks are fashioned to employ different calligraphy (first, second, third, quadrille, 5 mm, 6 mm, 7 mm and regular lines). As presently contemplated, the notebooks will be available in eight different, bright colors with matching double-pocket folders for homework and the like. Additional notebooks and folders will be made available individually if needed. The spines of the notebooks are colored the same as the notebook for easy identification.

Accordingly, the invention presents a unique system for improving an elementary student's ability to organize and thereby creating a better atmosphere for learning. The invention provides for improved elements thereof in an arrangement for the purposes described that are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1 is an environmental, perspective view of children's organizational notebooks according to the present invention.

FIG. 2 is a perspective view of children's organizational notebooks according to the present invention.

FIG. 3 is a perspective view of a carry-all bag for organizational notebooks according to the present invention.

FIG. 4 is a perspective view of a set of double-pocket folders and a steel ring holder therefor according to the present invention.

Similar reference characters denote corresponding features consistently throughout the attached drawings.

### DETAILED DESCRIPTION OF THE PREFERRED EMBODIMENTS

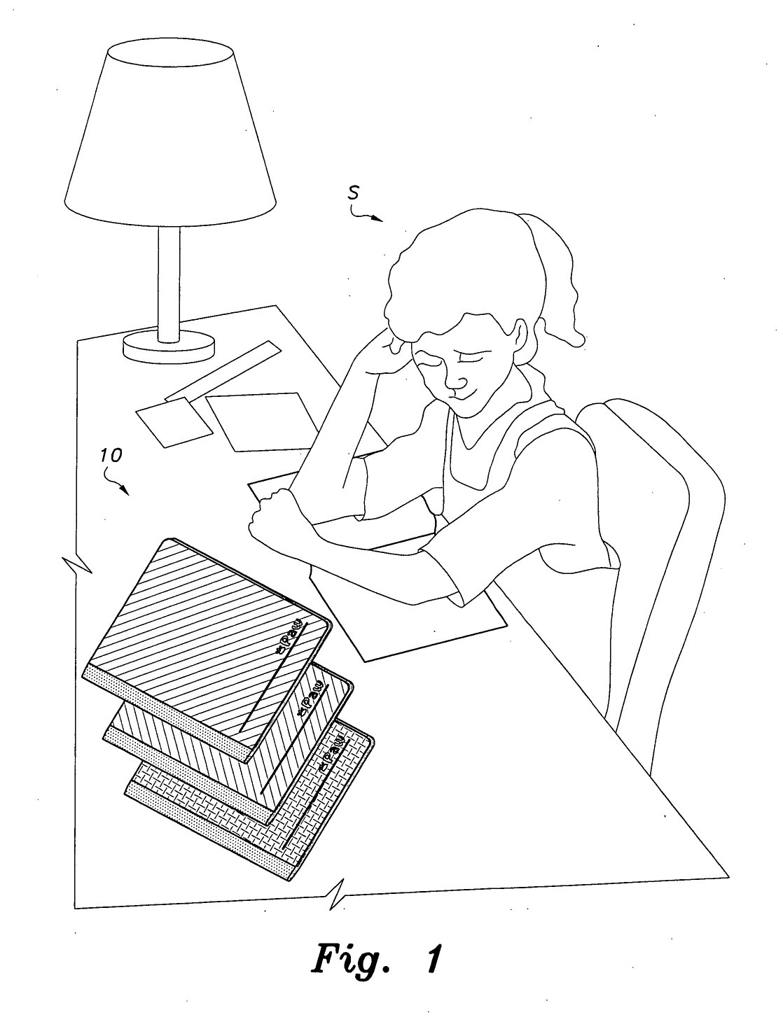

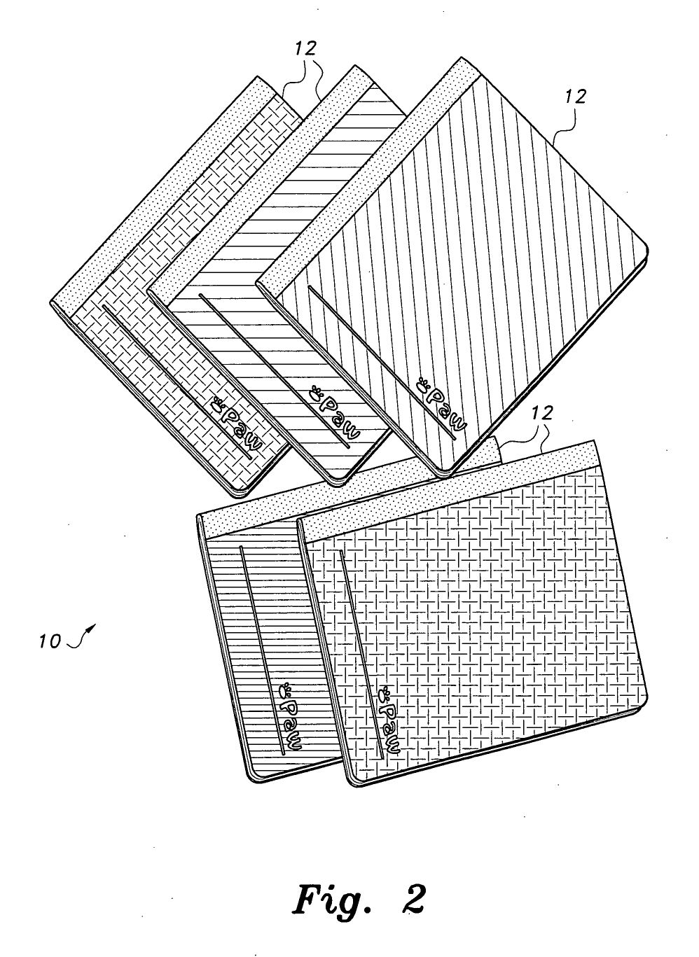

Attention is directed to FIGS. 1 and 2, wherein the children's organizational notebooks are generally indicated at 10. The notebooks 10 form a system comprising multiple notebooks 12. Each notebook 12 is of a different color, and each color represents a particular subject, as indicated above. This arrangement creates less confusion for the student S. The student is more likely to associate a color with a particular class, thereby organizing schoolwork by subject matter. Although five notebooks are shown, it should be recognized that the number of notebooks utilized would correspond to the number of classes taken by the student.

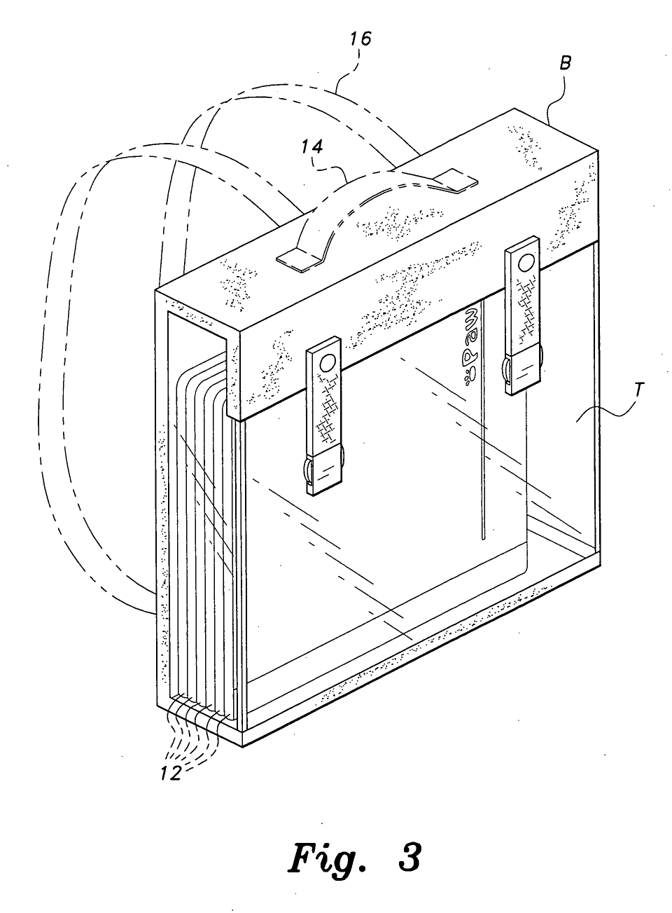

FIG. 3 discloses a carry-all bag B for transporting the notebooks 12 as described above. Bag B is fashioned with a transparent front T so that the contents can be readily viewed without opening the bag. The bag is provided with a handle 14 and removable shoulder straps 16 to enhance portability.

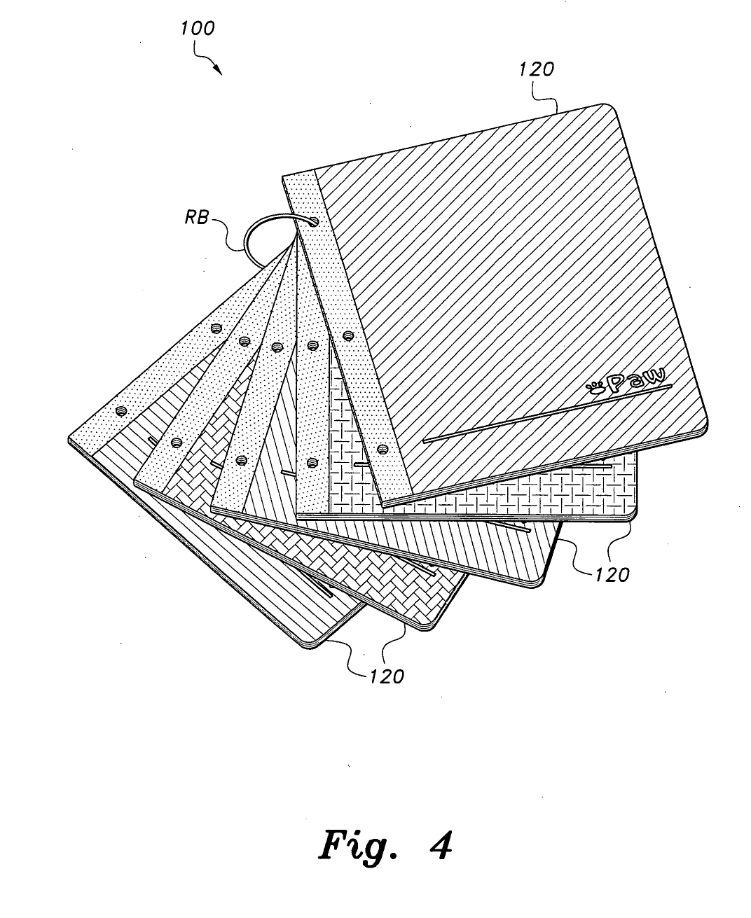

As best seen in FIG. 4 generally indicated at 100 a steel ring binder RB is employed to secure a set of double-pocket folders 120 together. The folders are also color-coded and are utilized for organizing documents related to each subject according to color.

It is to be understood that the present invention is not limited to the embodiments described above, but encompasses any and all embodiments within the scope of the following claims.

We claim:

1. A system of children's organizational notebooks for an elementary student, comprising:
a plurality of notebooks, each of the notebooks being fabricated to employ a particular calligraphy system; and
covers for identifying and differentiating between each of the notebooks in the plurality of notebooks.

2. The system according to claim 1, wherein said covers for identifying and differentiating between the notebooks comprise color-coded notebook covers.

3. The system according to claim 1, wherein said calligraphy system is selected from the group consisting of first, second, third, quadrille, 5 mm, 6 mm, 7 mm and regular lines.

4. A system of children's organizational notebooks for an elementary student, comprising:
a plurality of notebooks, each of the notebooks being fabricated to employ a particular calligraphy system, and wherein each of the notebooks relates to a particular academic subject; and
covers for identifying and differentiating between each of the notebooks in the plurality of notebooks.

5. The system according to claim 4, wherein said covers for identifying and differentiating between the notebooks comprise color-coded notebook covers.

6. The system according to claim 4, wherein said calligraphy system is selected from the group consisting of first, second, third, quadrille, 5 mm, 6 mm, 7 mm and regular lines.

7. A system of children's organizational notebooks for an elementary student, comprising:
a plurality of notebooks, each of the notebooks being fabricated to employ a particular calligraphy system selected from the group consisting of first, second, third, quadrille, 5 mm, 6 mm, 7 mm and regular lines, and wherein each of the notebooks relates to a particular academic subject;
color-coded notebook covers for identifying and differentiating between each, of the notebooks as the notebook relates to the particular academic subject and
a set of color-coded, double-pocket folders for organizing documents related to each particular academic subject.

8. The system according to claim 7, further including a carry-all bag housing said plurality of notebooks and said set of color-coded, double-pocket folders, said carry-all bag having a transparent front.

9. The system according to claim 8, further including a steel ring binder for holding said set of color-coded, double-pocket folders together.
